(19) United States
(12) Patent Application Publication
(10) Pub. No.: US 2026/0143541 A1
(43) Pub. Date: May 21, 2026

(54) TRAFFIC IDENTIFIER (TID)-TO-LINK MAPPING NEGOTIATION

(71) Applicant: Cisco Technology, Inc., San Jose, CA (US)

(72) Inventors: Binita Gupta, San Diego, CA (US); Brian D. Hart, Sunnyvale, CA (US)

(73) Assignee: Cisco Technology, Inc., San Jose, CA (US)

(21) Appl. No.: 19/391,619

(22) Filed: Nov. 17, 2025

Related U.S. Application Data
(60) Provisional application No. 63/721,172, filed on Nov. 15, 2024.

(51) Int. Cl. H04W 76/15; H04W 76/18

(52) U.S. Cl. CPC H04W 76/15; H04W 76/18

(57) ABSTRACT

Traffic Identifier (TID)-to-Link mapping negotiation may be provided. An Access Point (AP) Multi-Link Device (MLD) may maintain an association with a non-AP MLD. The association may include one or more setup links between the AP MLD and the non-AP MLD. The AP MLD may receive a link reconfiguration request frame from the non-AP MLD to add a first link to the one or more setup links of the association. The link reconfiguration request frame may include a requested Traffic-Identifier (TID)-To-Link Mapping (TTLM) for both existing one or more setup links and the first link that is being requested to be added. The AP MLD may generate a link reconfiguration response frame. Ahe AP MLD may send the link reconfiguration response frame to the non-AP MLD.

### RELATED APPLICATION

Under provisions of 35 U.S.C. § 119(e), Applicant claims the benefit of U.S. Provisional Application No. 63/721,172, filed Nov. 15, 2024, which is incorporated herein by reference.

### TECHNICAL FIELD

The present disclosure relates generally to Traffic Identifier (TID)-to-Link mapping negotiation.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing Traffic Identifier (TID)-to-Link Mapping (TTLM) negotiation;

FIG. 2 is a flow chart of a method for providing TTLM negotiation;

FIG. 3A illustrates an example link reconfiguration request frame action field format;

FIG. 3B illustrates an example link reconfiguration response frame action field format; and

FIG. 4 is a flow chart of another method for providing TTLM negotiation; and

FIG. 5 is a block diagram of a computing device.

### DETAILED DESCRIPTION

### Overview

Traffic Identifier (TID)-to-Link mapping negotiation may be provided. An Access Point (AP) Multi-Link Device (MLD) may maintain an association with a non-AP MLD. The association may include one or more setup links between the AP MLD and the non-AP MLD. The AP MLD may receive a link reconfiguration request frame from the non-AP MLD to add a first link to the one or more setup links of the association. The link reconfiguration request frame may include a requested Traffic-Identifier (TID)-To-Link Mapping (TTLM) for both existing one or more setup links and the first link that is being requested to be added. The AP MLD may generate a link reconfiguration response frame. Ahe AP MLD may send the link reconfiguration response frame to the non-AP MLD.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

With the emergence of dual-radio client devices and tri-band Access Points (APs) capable of simultaneously operating at 2.4 GHz, 5 GHz, and 6 GHz Radio Frequency (RF) bands, one of the objectives of the Institute of Electrical and Electronics Engineers (IEEE) 802.11be may be to make more efficient use of multiple bands and the channels therein. IEEE 802.11be may disclose Wi-Fi standards that may further enhance capabilities of wireless devices (e.g., IEEE 802.11ax devices) currently on the market. For example, a Multi-Link Device (MLD) may include multiple radios and antennas that may provide a capability of simultaneous operation on multiple channels. To take advantage of the multi-radio devices, 802.11be may provide Multi-Link Operation (MLO) that may provide may support Traffic Identifier (TID)-to-Link Mapping (TTLM) as a traffic management mechanism in wireless networks. With TTLM functionality, MLO compliant devices may transmit, receive, or transit and receive with different Quality-of-Service (QoS) standards over multiple links. That is, different TIDs may be mapped to different links, in order to minimize, for example, access delays for time-sensitive traffic. As a reference example, an Access Point (AP) may assign certain links (e.g., 5 gigahertz (GHz) link or 6 GHz link) to QoS-sensitive traffic (e.g., real-time collaborative applications, such as teleconferencing applications), and assign other links to other types of traffic, such as best effort traffic from a video streaming service.

The MLO procedures allow a pair of MLDs to discover, synchronize, (de)authenticate, (re)associate, disassociate, and manage links and other resources with each other on any common bands or channels that are supported by both MLDs. During association or reassociation (i.e., (re)association), a non-AP MLD can request one or more links in the (Re)Association Request frame, and the AP MLD can accept the one or more links in the (Re)Association Response frame. The one or more links added during association or reassociation are setup links. Thus, the IEEE 802.11be may define a link reconfiguration request/response exchange for add/delete link operation. When an add link operation is performed, by default all TIDs may be mapped to the added link. Later the non-AP MLD or AP MLD may initiate a TTLM negotiation to negotiate a different TTLM for the added link per the IEEE 802.11be. However, this procedure may not be optimal. For instance, this procedure may require an additional overhead of TTLM Request/Response exchange to setup a TTLM for the added link and may also add delay in implementing a desired TTLM on the added link.

Similarly, when a non-AP MLD (fir example, a Station (STA)) performs roaming to a target AP MLD using an add link request (e.g. a link reconfiguration Request) or another roaming request, the links that the STA may request to setup with the target AP MLD may need to have a non-default TTLM, and all TIDs may not be mapped to all the links established with the target AP MLD. Here again, the non-AP MLD may need to perform a separate TTLM negotiation with the target AP MLD after it roams which adds the overhead and delay for a desired TTLM to be established. Embodiments of the disclosure may provide an enhancement to avoid this additional overhead and delay for TTLM establishment for added links.

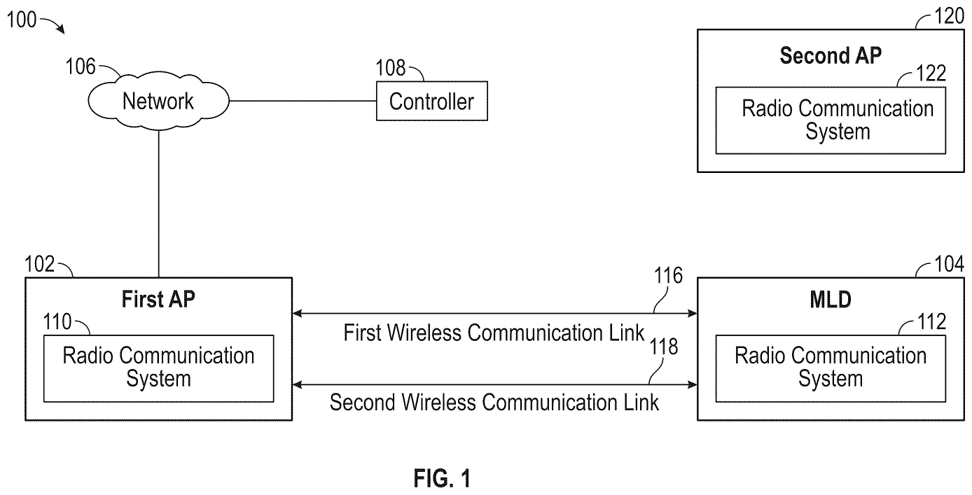

FIG. 1 shows an operating environment 100 for TTLM negotiation. As shown in FIG. 1, operating environment 100 may include a first AP MLD 102, a non-AP MLD 104, a network 106, a controller 108, and a second AP MLD 120. Operating environment 100 is not so limited and may include multiple AP MLDs and multiple non-AP MLDs. Non-AP MLD 104 may be associated with one or more AP MLDs, including first AP MLD 102 and second AP MLD 120. An example first AP MLD 102 may include a first integrated radio communication system 110 that may include a plurality of radios and antennas. Likewise, non-AP MLD 104 may include a second integrated radio communication system 112 that may include a plurality of radios and antennas. First radio communication system 110 and second radio communication system 112 may be operable to communicate on multiple Wireless Communication Links (WCLs) or channels. First AP MLD 102 and non-AP MLD 104 may respectively use first integrated radio communication systems 110 and second radio communication system 112 to establish communication over wireless network 106 (e.g., a Wireless Local Area Network (WLAN)).

As shown in FIG. 1, a first WCL 116 and a second WCL 118 have been established between first AP MLD 102 and non-AP MLD 104 according to the IEEE 802.11 wireless protocol for example. However, non-AP MLD 104 may establish first WCL 116 and second WCL 118 with different AP MLDs, including first AP MLD 102 and second AP MLD 120. In some cases, depending on the capabilities of first AP MLD 102 and non-AP MLD 104, it may be possible to utilize multiple spatial streams (e.g., 4, 8, 16, etc.) to communicate within operating environment 100.

Each of first AP MLD 102 and second AP MLD 120 may be a networking hardware device that enables other devices, such as non-AP MLD 104, to connect to network 106. As an example, first AP MLD 102 and second AP MLD 120, each, may be configured with a multi-radio software controller for use with Long Term Evolution (LTE), Wireless Fidelity (Wi-Fi), Worldwide Interoperability for Microwave Access (WiMAX), Global System for Mobile (GSM) Communications, Code Division Multiple Access (CDMA), Wideband Code Division Multiple Access (WCDMA), etc. that may include N (e.g., 2, 4, 8, 16, etc.) independent 2×2 transceivers, N independent two channel receivers or sniffers, a radio frequency band from about 70 Megahertz (MHz) to about 6 Gigahertz (GHz) for example, and a tunable channel bandwidth.

Non-AP MLD 104 may comprise, but is not limited to, an AP, a phone, a smartphone, a digital camera, a tablet device, a laptop computer, a personal computer, a mobile device, a sensor, an Internet-of-Things (IoTs) device, a cellular base station, a telephone, a remote control device, a set-top box, a digital video recorder, a cable modem, a network computer, a mainframe, a router, or any other similar microcomputer-based device capable of accessing and using a Wi-Fi network.

Controller 108 may comprise a Wireless Local Area Network controller (WLC) and may provision and control operating environment 100 (e.g., the WLAN). Controller 108 may allow the plurality of client devices to join operating environment 100. In some embodiments of the disclosure, controller 108 may be implemented by a Digital Network Architecture Center (DNAC) controller (i.e., a Software-Defined Network (SDN) controller).

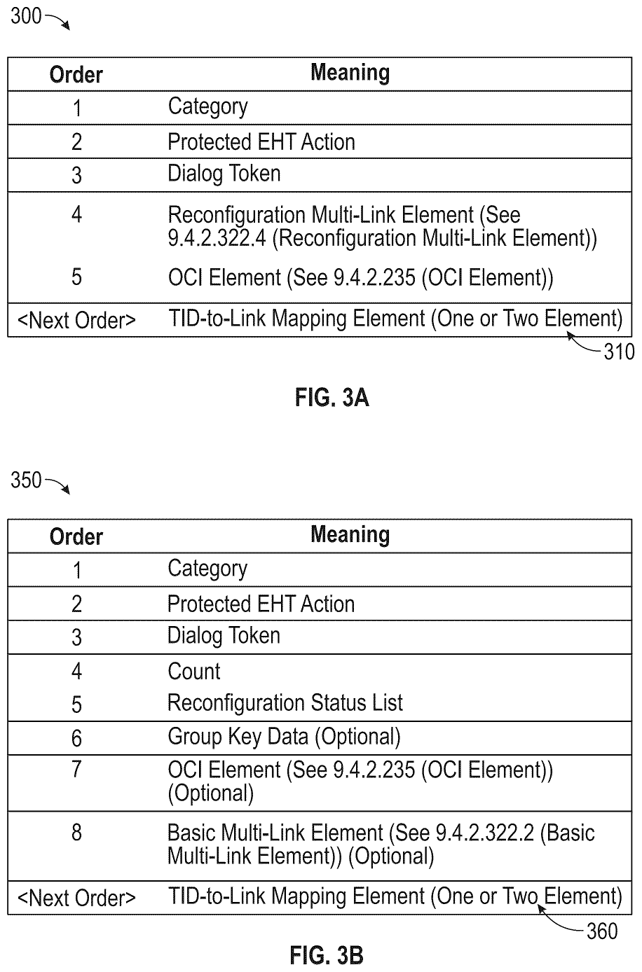

The elements described above of operating environment 100 (e.g., first AP MLD 102, second AP MLD 120, non-AP MLD 104, and controller 108) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

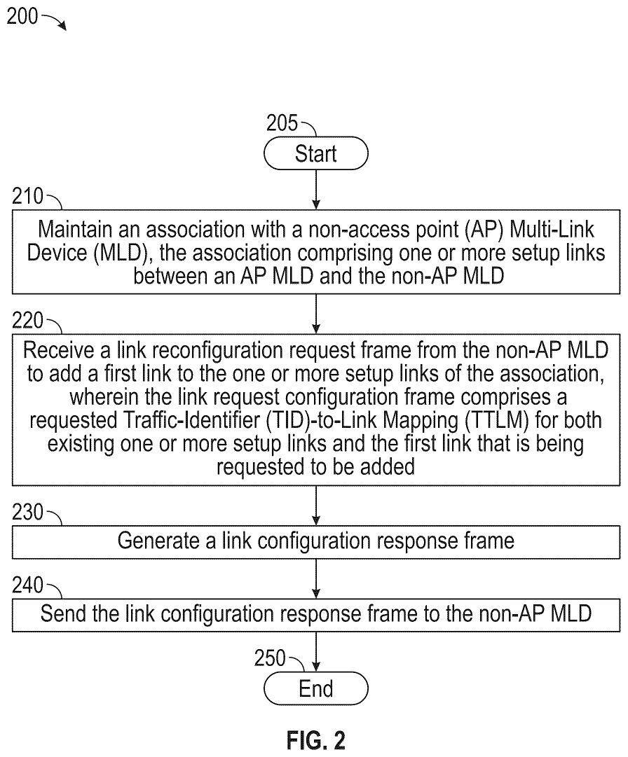

FIG. 2 is a flow chart setting forth the general stages involved in a method 200 consistent with an embodiment of the disclosure for TTLM negotiation. Method 200 may be implemented using first AP MLD 102 as described in more detail above with respect to FIG. 1. Ways to implement the stages of method 200 will be described in greater detail below.

Method 200 may begin at starting block 205 and proceed to stage 210 where first AP MLD 102 may maintain an association with non-AP MLD 104. The association may include one or more setup links between first AP MLD 102 and non-AP MLD 104. For example, the association may include first WCL 116 between first AP MLD 102 and non-AP MLD 104.

From stage 210, where first AP MLD 102 maintains the association with non-AP MLD 104, method 200 may advance to stage 220 where first AP MLD 102 may receive a link reconfiguration request frame from non-AP MLD 104 to add a first link to the one or more setup links of the association. The link request reconfiguration frame may include a requested TTLM for both existing one or more setup links and the first link that is being requested to be added to the association. In some examples, the link request reconfiguration frame (also referred to as an add link request) may include a request to add more than one links. First AP MLD 102 may receive the link reconfiguration request frame from non-AP MLD 104 on the existing one or more setup links.

In some examples, non-AP MLD 104 may generate the link reconfiguration request frame in response to an indication (for example, based on channel conditions, traffic demand, QoS requirements, etc.) to add a link, for example, second WCL 118. Non-AP MLD 104 may include a requested TTLM in the add link request where the requested TTLM may cover mapping for both the existing one or more setup links and the new link that is being requested in the same link request reconfiguration frame.

Once first AP MLD 102 receives the link reconfiguration request frame from non-AP MLD 104 in stage 220, method 200 may continue to stage 230 where first AP MLD 102 may generate a link reconfiguration response frame. For example, first AP MLD 102 may fully accept the add link request, fully reject the add link request, or partially accept the add link request. First AP MLD 102 may then generate the link reconfiguration response frame indicating an outcome of the add link request.

From stage 230, where first AP MLD 102 generates the link reconfiguration response frame, method 200 may advance to stage 240 where first AP MLD 102 may send the link reconfiguration response frame to non-AP MLD 104. First AP MLD 102 may send the link reconfiguration response frame on the existing one or more setup links. Once having sent the link reconfiguration response frame to non-AP MLD 104, method 200 may terminate at END block 250.

First AP MLD 102 may accept none, some, or all add links requested in the link reconfiguration request frame. In one example, if no change is accepted by first AP MLD 102, then the TTLM request may be auto discarded and the existing TTLM agreement may be maintained.

In another example, given that each of the N links requested by non-AP MLD 104 may be accepted or rejected, non-AP MLD 104 may include 2^{N} variants of the TTLM request, one per possible add link request outcome. However, including 2^{N} variants of the TTLM request may become difficult to manage and may slow down the process, in some implementations, non-AP MLD 104 may provide a simplified set of TTLM requests. For example, non-AP MLD 104 may provide one TTLM request per number of accepted links. In another example, non-AP MLD 104 may provide length-N “if-else” sequence of TTLM requests such that if a link A is accepted (irrespective of whatever happens to the other requested links), then use TTLM_A (where disallowed links are automatically dropped from the TTLM request), else if a link B is accepted, then use TTLM_B, . . . , else if a link N is accepted, then use TTLM_N. In this example implementation, non-AP MLD 104 may be able to select ordering of links A, B, C, etc. (for example, non-AP MLD 104 may set A=6 GHz, B=5 GHz, etc.) or non-AP MLD 104 may follow some other ordering such as by ascending or descending link ID.

In one example implementation, if first AP MLD 102 accepts the requested TTLM for the existing and new links (that are accepted by first AP MLD 102), then in the link reconfiguration response frame, first AP MLD 103 may not include a TTLM element. The absence of a TTLM element in the link reconfiguration response frame may signal that the requested TTLM covering the existing and added links (that are accepted by first AP MLD 102 in the link reconfiguration response frame) is accepted by first AP MLD 102.

In another example implementation, if first AP MLD 102 does accept the TTLM request then first AP MLD 102 may send a TTLM element indicating success and/or the TTLM element may echo the requested TTLM from the link reconfiguration request frame. Alternatively, when first AP MLD 102 may not accept the requested TTLM, including for the existing and the added links, then first AP MLD 102 may include a different TTLM element in the link reconfiguration response frame. The different TTLM element may include a different TTLM (also referred to as a proposed TTLM or recommended TTLM) than the requested TTLM.

A proposed TTLM from first AP MLD 102 may be signaled by first AP MLD 102 or defined by in the IEEE 802.11be standard from one or more of the following example implementations. In a first example implementation, first AP MLD 102 may reject the requested TTLM, with an indication (defined in the IEEE 802.11be standard or signaled) that non-AP MLD 104 may not negotiate further or may not negotiate for a predetermined extended time, where the predetermined extended time may either be defined in the IEEE 802.11be standard or included in the link reconfiguration response frame. If non-AP MLD 104 does not agree to the TTLM rejection in the link reconfiguration response frame and/or for the extended time duration (if applicable), non-AP MLD 104 may disassociate from first AP MLD 102. Else, non-AP MLD 104 may may accept the proposed TTLM element silently (that is, without sending any response frame to the TTLM rejection) or may send another TTLM frame indicating “accept”.

In a second example implementation, first AP MLD 102 may reject non-AP MLD's 104 request but with an indication (defined in the IEEE 802.11be standard or signaled) that non-AP MLD 104 may negotiate further. In this second example implementation, non-AP MLD 104 may accept silently (that is, without sending any response) or may send an updated TTLM request frame or a TTLM response frame indicating “accept”. Alternatively, initially non-AP MLD 104 may accept silently and then may send a new, standalone TTLM request with an alternative TTLM request that may be more palatable to first AP MLD 102.

In a third example implementation, first AP MLD 102 may override non-AP MLD's 104 TTLM request with a response TTLM with an immediate force, with an indication (defined in the IEEE 802.11be standard or signaled) that non-AP MLD 104 may not negotiate further or may not negotiate for some extended time, where the extended time may either be defined in the IEEE 802.11be standard or included in the link reconfiguration response frame. If non-AP MLD 104 does not agree to the response TTLM in the link reconfiguration response frame, non-AP MLD 104 may disassociate from first AP MLD 104. In the meantime, non-AP MLD 104 may have to follow the response TTLM. If non-AP MLD 104 may live with the override, at least until the predetermined extended time elapses, either non-AP MLD 104 may accept silently or may send a TTLM request or response frame indicating “accept”.

In a fourth example implementation, first AP MLD 104 may override non-AP MLD's 104 TTLM request with a response TTLM with an immediate force, with an indication (defined in the IEEE 802.11be standard or signaled) that non-AP MLD 104 may negotiate further. In the fourth implementation, non-AP MLD 104 may accept silently or send a TTLM frame indicating “accept”. Alternatively, non-AP MLD 104 may initially accept silently then may send a new, standalone TTLM request with an alternative TTLM that may be more palatable to first AP MLD 102 (e.g., leans towards first AP MLD's 102 override). First AP MLD 102 may accept or reject the alternative TTLM or reject with a counterproposal.

In a fifth example implementation, first AP MLD 102 may reject the requested TTLM with a counterproposal. Non-AP MLD 104 may send a new standalone TTLM request with the exact first AP MLD's 102 proposed TTLM (or possibly a subset thereof), and first AP MLD 102 may accept the new standalone TTLM request in a TTLM response. In a sixth implementation, first AP MLD 102 may accept the requested TTLM.

The request/response exchange for the add link request may include link reconfiguration request/response frames exchange as defined in IEEE 802.11be. The link reconfiguration request/response frames may be enhanced to enable the TTLM negotiation. In on example implementation, the link reconfiguration request frame defined in the IEEE 802.11be for add link may be modified to include one or two TTLM elements (two if UL and DL are different) outside the reconfiguration multi-link element. FIG. 3A illustrates an example link reconfiguration request frame action field format 300. As shown in FIG. 3A, link reconfiguration request frame action field format 300 is enhanced to include TTLM element(s) 310. Added TTLM element(s) 310 may provide the requested TTLM by non-AP MLD 104 that may cover the existing one or more links and (one or more) new links that are requested for add link operation in the same link reconfiguration request frame.

If first AP MLD 102 accepts the requested TTLM over the existing one or more links and accepted add links, then first AP MLD may not include any TTLM element in the link reconfiguration response frame (as one example implementation). Else, if first AP MLD 102 does not accept the requested TTLM over the existing one or more links and accepted add links, then it may include one or two TTLM element in the link reconfiguration response frame. FIG. 3B illustrates an example link reconfiguration response frame action field format 350. As shown in FIG. 3B, link reconfiguration response frame action field format 350 is enhanced to include TTLM element(s) 370. In one implementation, and as discussed above, TTLM elements 370 may include a preferred TTLM that non-AP MLD 104 may use later to perform TTLM negotiation (i.e., the reject with counterproposal frame exchange embodiment).

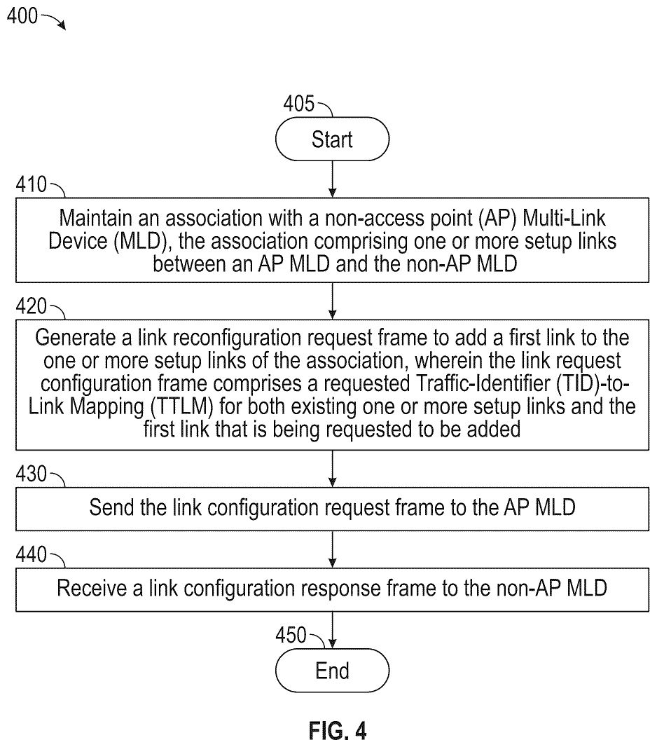

FIG. 4 is a flow chart setting forth the general stages involved in a method 400 consistent with an embodiment of the disclosure for TTLM negotiation. Method 400 may be implemented using non-AP MLD 104 as described in more detail above with respect to FIG. 1. Ways to implement the stages of method 400 will be described in greater detail below.

Method 400 may begin at starting block 405 and proceed to stage 410 where non-AP MLD 104 may maintain an association with first AP MLD 102. The association may include one or more setup links between first AP MLD 102 and non-AP MLD 104. For example, the association may include first WCL 116 between first AP MLD 102 and non-AP MLD 104.

From stage 410, where non-AP MLD 102 maintains the association with first AP MLD 102, method 400 may advance to stage 420 where non-AP MLD 102 may generate a link reconfiguration request frame to add a first link to the one or more setup links of the association. The link request reconfiguration frame may include a requested TTLM for both existing one or more setup links and the first link that is being requested to be added.

In some examples, and as discussed above, non-AP MLD 104 may generate the link reconfiguration request frame in response to an indication (for example, based on channel conditions, traffic demand, QoS requirements, etc.) to add a link, for example, second WCL 118. Non-AP MLD 104 may include a requested TTLM in the add link request where the requested TTLM may cover mapping for existing setup links and the new links that are being requested in the same link request reconfiguration frame.

Once non-AP MLD 104 generates the link reconfiguration request frame in stage 420, method 400 may continue to stage 430 where non-AP MLD 104 may send the link reconfiguration request frame to first AP MLD 102. In some examples, non-AP MLD 104 may send the link reconfiguration request frame over the one or more setup links of the association.

From stage 430, where non-AP MLD 104 sends the link reconfiguration request frame to first AP MLD 102, method 400 may advance to stage 440 where non-AP MLD 104 may receive a link reconfiguration response frame from first AP MLD 102. For example, first AP MLD 102 may generate the link reconfiguration response frame in response to receiving the link reconfiguration request frame. As discussed above, first AP MLD 102 may fully accept the add link request, fully reject the add link request, or partially accept the add link request. First AP MLD 102 may then generate the link reconfiguration response frame indicating an outcome of the add link request. First AP MLD 102 may send the link reconfiguration response frame on the existing one or more setup links. Once having received the link reconfiguration response frame from first AP MLD 102, method 200 may terminate at END block 250.

When non-AP MLD 104 roams from a current/serving AP MLD (that is, first AP MLD 102) to a target AP MLD (for example, second AP MLD 120), non-AP MLD 104 may also perform TTLM negotiation as part of the roaming exchange. The roaming may include a roaming preparation phase and a roaming execution/transition phase. The TTLM negotiation with second AP MLD 120 may be performed as part of either the roaming preparation phase or the roaming execution/transition phase. In one implementation, it may be preferrable to perform the TTLM negotiation with second AP MLD 120 as part of the roaming preparation.

In the roaming request (that is, either the roaming preparation request or the roaming execution request), non-AP MLD 104 may include the requested TTLM for the requested links with second AP MLD 120 in the same request. Like above, the roaming request may include one or two TTLM elements indicating the requested TTLM over the links that are being requested with second AP MLD 120.

Second AP MLD 120 may accept some or all the requested links in the roaming request. In the roaming preparation phase these links may not be activated yet. In one implementation, if second AP MLD 120 accepts the requested TTLM for the links that it has accepted (accepted links are signaled in the roaming response), then second AP MLD 120 may not include any TTLM element in the roaming response. Else, if second AP MLD 120 does not accept the requested TTLM over the accepted links, then it includes one or two TTLM elements in the roaming response suggesting a preferred TTLM that non-AP MLD 104 may use later to perform the TTLM negotiation with second AP MLD 120 (i.e., the reject with counterproposal frame exchange embodiment). In this case, in one embodiment, the default TTLM (all-to-all) is assumed for all the links with the target AP MLD, until a new TTLM is negotiated. In this case, in another embodiment, the status quo TTLM is assumed for the already-setup links and the default TTLM (i.e., all TIDs enabled on these links) is assumed for the new links with the target AP MLD, until a new TTLM is negotiated.

In one implementation, the target AP MLD may explicitly indicate that it has accepted the requested TTLM in the roaming response. In another implementation, the target AP MLD may indicate a status code indicating that the requested TTLM is rejected in the roaming response.

In one implementation, non-AP MLD 104 may request to transfer the TTLM from the serving AP MLD links to the target AP MLD links. For example, if the serving AP MLD and the target AP MLD both have 3 links (2.4, 5 and 6 GHz), then non-AP MLD 104 may maintain the same TTLM on the target AP MLD as well and hence may request to transfer the current TTLM, instead of renegotiating the TTLM with the target AP MLD.

Thus, the disclosure may provide a process to optimize establishment of TTLM for the added links with the current AP MLD or with (one or more) target AP MLDs during roaming. This reduces overhead and delay for establishment of TTLM for new links and for roaming.

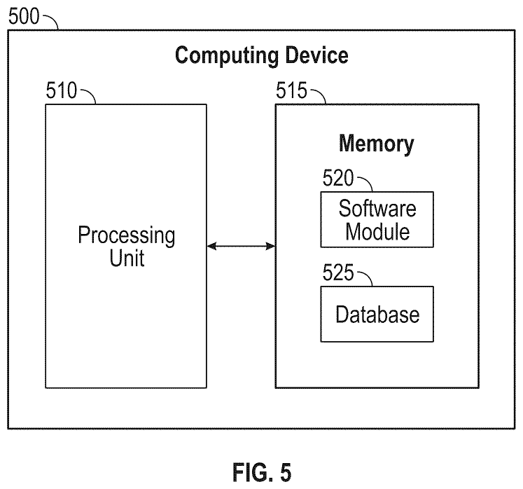

FIG. 5 shows computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for providing TTLM negotiations as described above with respect to FIG. 2 and FIG. 4. Computing device 500, for example, may provide an operating environment for first AP MLD 102, non-AP MLD 104, controller 108, and second AP MLD 120. First AP MLD 102, non-AP MLD 104, controller 108, and second AP MLD 120 may operate in other environments and are not limited to computing device 500.

Computing device 500 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
maintaining, by an Access Point (AP) Multi-Link Device (MLD), an association with a non-AP MLD, the association comprising one or more setup links between the AP MLD and the non-AP MLD;
receiving, by the AP MLD, a link reconfiguration request frame from the non-AP MLD to add a first link to the one or more setup links of the association, wherein the link reconfiguration request frame comprises a requested Traffic-Identifier (TID)-To-Link Mapping (TTLM) for both existing one or more setup links and the first link that is being requested to be added;
generating, by the AP MLD, a link reconfiguration response frame; and
sending, by the AP MLD, the link reconfiguration response frame to the non-AP MLD.

2. The method of claim 1, wherein receiving the link reconfiguration request frame comprises receiving the link reconfiguration request frame to add more than one link, and wherein the link reconfiguration request frame further comprises a one TTLM request per number of accepted links.

3. The method of claim 1, wherein generating the link reconfiguration response frame comprises not including a TTLM element in the link reconfiguration response frame in response to accepting the requested TTLM from the link reconfiguration request frame.

4. The method of claim 1, wherein generating the link reconfiguration response frame comprises including a TTLM element indicating success in the link reconfiguration response frame in response to accepting the requested TTLM from the link reconfiguration request frame.

5. The method of claim 1, wherein generating the link reconfiguration response frame comprises including a TTLM element that includes a proposed TTLM or a recommended TTLM that is different than the requested TTLM.

6. The method of claim 1, wherein generating the link reconfiguration response frame comprises overriding the requested TTLM with a response TTLM with an immediate force with an indication that the non-AP MLD cannot negotiate for a predetermined extended time.

7. The method of claim 6, wherein the predetermined extended time is included in the link reconfiguration response frame.

8. The method of claim 6, further comprising:
disassociating, by the non-AP MLD, from the AP MLD in response to the non-AP MLD not agreeing to the response TTLM in the link reconfiguration response frame.

9. The method of claim 6, further comprising:
receiving, at the end of the predetermined extended time, a TTLM request or response frame indicating acceptance of the response TTLM.

10. A system comprising:
a memory storage; and
a processing unit coupled to the memory storage, wherein the processing unit is operative to:
maintain an association with an Access Point (AP) Multi-Link Device (MLD), the association comprising one or more setup links between the AP MLD and a non-AP MLD;
generate a link reconfiguration request frame to add a first link to the one or more setup links of the association, wherein the link reconfiguration request frame comprises a requested Traffic-Identifier (TID)-To-Link Mapping (TTLM) for both existing one or more setup links and the first link that is being requested to be added;
send the link reconfiguration request frame to the AP MLD; and
receive a link reconfiguration response frame from the AP MLD.

11. The system of claim 10, wherein the processing unit is further operative to:
responsive to the link reconfiguration response frame indicating a success, add the first link to the one or more setup links of the association between the AP MLD and the non-AP MLD.

12. The system of claim 10, wherein the processing unit being operative to receive the link reconfiguration request frame comprises the processing unit being operative to receive the link reconfiguration request frame to add more than one link, and wherein the link reconfiguration request frame further comprises a one TTLM request per number of accepted links.

13. The system of claim 8, wherein the processing unit being operative to generate the link reconfiguration response frame comprises the processing unit being operative to not include a TTLM element in the link reconfiguration response frame in response to accepting the requested TTLM from the link reconfiguration request frame.

14. A computer-readable medium that stores a set of instructions which when executed perform a method executed by the set of instructions comprising:
maintaining, by an Access Point (AP) Multi-Link Device (MLD), an association with a non-AP MLD, the association comprising one or more setup links between the AP MLD and the non-AP MLD;
receiving, by the AP MLD, a link reconfiguration request frame from the non-AP MLD to add a first link to the one or more setup links of the association, wherein the link reconfiguration request frame comprises a requested Traffic-Identifier (TID)-To-Link Mapping (TTLM) for both existing one or more setup links and the first link that is being requested to be added;
generating, by the AP MLD, a link reconfiguration response frame; and
sending, by the AP MLD, the link reconfiguration response frame to the non-AP MLD.

15. The computer-readable medium of claim 14, wherein receiving the link reconfiguration request frame comprises receiving the link reconfiguration request frame to add more than one link, and wherein the link reconfiguration request frame further comprises a one TTLM request per number of accepted links.

16. The computer-readable medium of claim 14, wherein generating the link reconfiguration response frame comprises not including a TTLM element in the link reconfiguration response frame in response to accepting the requested TTLM from the link reconfiguration request frame.

17. The computer-readable medium of claim 14, wherein generating the link reconfiguration response frame comprises including a TTLM element that includes a proposed TTLM or a recommended TTLM that is different than the requested TTLM.

18. The computer-readable medium of claim 14, wherein generating the link reconfiguration response frame comprises overriding the requested TTLM with a response TTLM with an immediate force with an indication that the non-AP MLD cannot negotiate for a predetermined extended time.

19. The computer-readable medium of claim 18, wherein the predetermined extended time is included in the link reconfiguration response frame.

20. The computer-readable medium of claim 18, further comprising:
disassociating, by the non-AP MLD, from the AP MLD in response to the non-AP MLD not agreeing to the response TTLM in the link reconfiguration response frame.
